(19) United States
(12) Patent Application Publication
(10) Pub. No.: US 2009/0113011 A1
(43) Pub. Date: Apr. 30, 2009

(54) Image processing system, image processing apparatus, mail server, and method of sending email

(75) Inventor: Nobuhiro Kuribara, Tokyo (JP)

Correspondence Address: KUBOTERA & ASSOCIATES, LLC, Suite 202, 200 Daingerfield Road, Alexandria, VA, 22314, US

(73) Assignee: Oki Data Corporation

(21) Appl. No.: 12/289,562

(22) Filed: Oct. 30, 2008

(30) Foreign Application Priority Data
Oct. 31, 2007 (JP) 2007-283491
Oct. 2, 2008 (JP) 2008-257846

(51) Int. Cl. G06F 15/16

(52) U.S. Cl. 709/206; 709/227

(57) ABSTRACT

An image processing system includes an image processing apparatus and a mail server connected to the image processing apparatus through a network. The image processing apparatus includes a first communication unit for receiving a normal reception command from the mail server indicating that the mail server normally receives an email; and an invalidation request command generation unit for generating an invalidation request command for requesting invalidation of the email when the invalidation request command generation unit receives a direction for requesting invalidation of the email sent to the mail server after the first communication unit receives the normal reception command. The mail server includes a second communication unit for sending the normal reception command to the image processing apparatus after the mail server normally receives the email; and a mail deletion unit for deleting the email specified by the invalidation request command when the mail deletion unit receives the invalidation request command sent from the image processing apparatus.

### BACKGROUND OF THE INVENTION AND RELATED ART STATEMENT

The present invention relates to an image processing system and an image processing apparatus for sending an email to a mail server, and a mail server for receiving an email. The present invention further relates to a method of sending an email to a mail server.

A conventional image processing apparatus includes, in addition to a function of simply processing an image, a function of sending an email to a mail server after the conventional image processing apparatus reads an image on an original and attaches an image file formed of image data constituting the image to the email (refer to Patent Reference).

Patent Reference: Japan Patent Publication No. 07-131480 In the conventional image processing apparatus with the function described above, once the conventional image processing apparatus starts sending an email with an image file attached thereto to a mail server, it is not possible to cancel transmission of the email. In order to delete the email sent to a mailbox of the mail server, it is necessary for a sender of the email to contact an administrator of the mail server through an email or telephone to request deletion of the email thus sent. According to the request from the sender of the email, the administrator of the mail server deletes the email with the image file attached thereto.

### SUMMARY OF THE INVENTION

According to a first aspect of the present invention, an image processing system includes an image processing apparatus and a mail server connected to the image processing apparatus through a network.

In the first aspect of the present invention, the image processing apparatus includes a first communication unit for receiving a normal reception command from the mail server indicating that the mail server normally receives an email; and an invalidation request command generation unit for generating an invalidation request command for requesting invalidation of the email when the invalidation request command generation unit receives a direction for requesting invalidation of the email sent to the mail server after the first communication unit receives the normal reception command.

In the first aspect of the present invention, the mail server includes a second communication unit for sending the normal reception command sent from the image processing apparatus to the image processing apparatus after the mail server normally receives the email; and a mail deletion unit for deleting the email specified by the invalidation request command when the mail deletion unit receives the invalidation request command sent from the image processing apparatus.

According to a second aspect of the present invention, an image processing apparatus connected to a mail server includes a communication unit for receiving a normal reception command from the mail server indicating that the mail server normally receives an email; and an invalidation request command generation unit for generating an invalidation request command for requesting invalidation of the email when the invalidation request command generation unit receives a direction for requesting invalidation of the email sent to the mail server after the communication unit receives the normal reception command.

According to a third aspect of the present invention, a mail server is connected to a communication apparatus through a network. The mail server includes a mail deletion unit for deleting an email specified by an invalidation request command upon receiving the invalidation request command sent from the communication apparatus.

According to a fourth aspect of the present invention, a method of sending an email from a communication apparatus to a mail server through a network includes the steps of: generating an invalidation request command with the communication apparatus for requesting invalidation of the email when a direction for requesting invalidation of the email sent to the mail server is received; sending the invalidation request command to mail server; and deleting the email specified by the invalidation request command with the mail server when the invalidation request command is received.

In the present invention, the invalidation request command generation unit of the image processing apparatus generates the invalidation request command for requesting invalidation of the email sent to the mail server after the first communication unit receives the normal reception command. Then, the mail deletion unit of the mail server deletes the email when the mail deletion unit receives the invalidation request command from the image processing apparatus.

Accordingly, it is not necessary for a sender of an email to contact an administrator of the mail server through an email or telephone to request deletion of the email thus sent. Further, the administrator of the mail server does not need to delete the email.

### BRIEF DESCRIPTION OF THE DRAWINGS

FIG. 1 is a block diagram showing an image processing system according to a first embodiment of the present invention;

FIG. 2 is a block diagram showing an image processing apparatus of the image processing system according to the first embodiment of the present invention;

FIG. 3 is a schematic view showing an operational panel of the image processing apparatus according to the first embodiment of the present invention;

FIG. 4 is a flow chart showing an operation of the image processing apparatus according to the first embodiment of the present invention;

FIG. 5 is a sequence chart showing a sequence between the image processing apparatus and a mail server according to the first embodiment of the present invention;

FIG. 6 is a block diagram showing an image processing system according to a modified example of the first embodiment of the present invention;

FIG. 7 is a block diagram showing an image processing apparatus of an image processing system according to a second embodiment of the present invention;

FIG. 8 is a schematic view showing an operational panel of the image processing apparatus according to the second embodiment of the present invention; and

FIG. 9 is a flow chart showing an operation of the image processing apparatus according to the second embodiment of the present invention.

### DETAILED DESCRIPTION OF THE PREFERRED EMBODIMENTS

Hereunder, embodiments of the present invention will be described in detail with reference to the accompanying drawings.

### First Embodiment

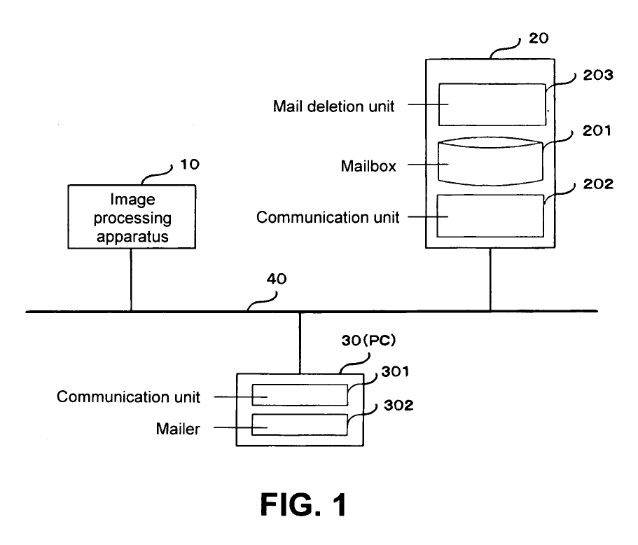

A first embodiment of the present invention will be explained. FIG. 1 is a block diagram showing an image processing system according to the first embodiment of the present invention.

As shown in FIG. 1, the image processing system includes an image processing apparatus 10; a mail server 20; a personal computer (PC) 30; and an IP network 40 connected to the image processing apparatus 10, the mail server 20, and the personal computer 30.

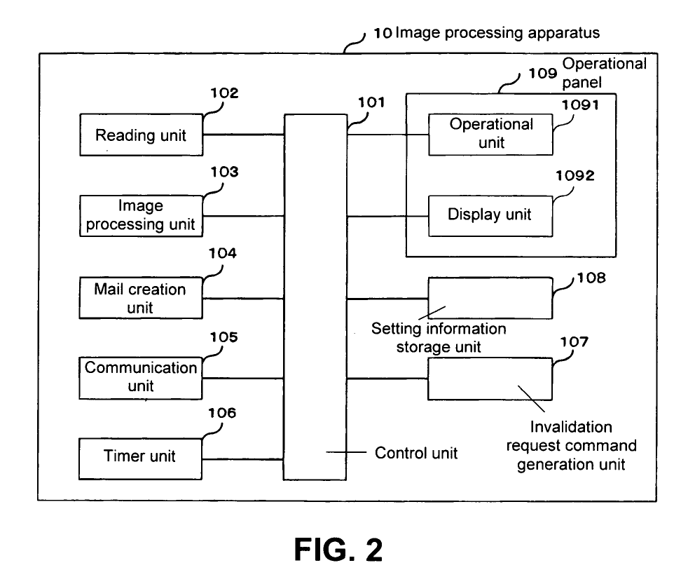

FIG. 2 is a block diagram showing the image processing apparatus 10 of the image processing system according to the first embodiment of the present invention.

As shown in FIG. 2, the image processing apparatus 10 includes a control unit 101; a reading unit 102; an image processing unit 103; a mail creation unit 104; a communication unit 105; a timer unit 106; an invalidation request command generation unit 107; a setting information storage unit 108; and an operational panel 109.

In the embodiment, a CPU (Central Processing Unit, not shown) executes a program stored in an ROM (Read Only Memory, not shown) to constitute the control unit 101, the reading unit 102, the image processing unit 103, the mail creation unit 104, the communication unit 105, the timer unit 106, and the invalidation request command generation unit 107 each having a function described below.

In the embodiment, the image processing apparatus 10 is assigned with an IP address of “192.168.100.100”, and an email address of “mjp@sample.com”. Further, as shown in FIG. 1, the image processing apparatus 10 is connected to the mail server 20 assigned with an IP address of “192.168.100.200” and the personal computer 30 assigned with an email address of “user@sample.com” through the IP network 40.

In the embodiment, the control unit 101 controls the reading unit 102, the image processing unit 103, the mail creation unit 104, the communication unit 105, the timer unit 106, the invalidation request command generation unit 107, the setting information storage unit 108, and the operational panel 109.

In the embodiment, the reading unit 102 includes a CCD (Charge-Coupled Device) for reading an original image. When the control unit 101 sends a reading start request to the reading unit 102 for requesting to start reading, the reading unit 102 starts reading an original image, and sends an image signal of the original image to the image processing unit 103 through the control unit 101.

In the embodiment, when the reading unit 102 sends the image signal of the original image to the image processing unit 103 through the control unit 101, the image processing unit 103 creates image data formed of 8 bits, and stores the image data thus created in an RAM (Random Access Memory). Note that the image processing unit 103 creates the image data having a file format of, for example, PDF, TIFF, GIF, or JPEG.

In the embodiment, when the control unit 101 sends an email creation request to the mail creation unit 104, the mail creation unit 104 writes a header of an email using input information input in input columns in an email transmission display screen such as a destination input column for inputting a destination, an origination input column for inputting an origination, and a subject column for inputting a subject. Further, the mail creation unit 104 creates a text and an email with a file formed of the image data read from the RAM attached thereto as an attachment. Then, the mail creation unit 104 sends the email thus created to the communication unit 105 through the control unit 101.

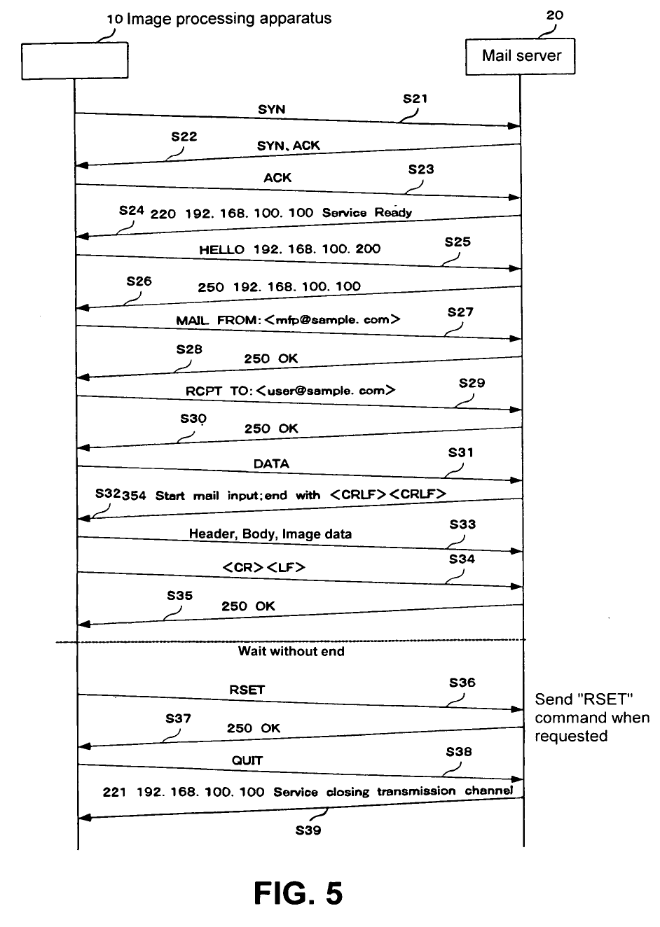

In the embodiment, when the mail creation unit 104 sends the email to the communication unit 105, the communication unit 105 sends the email to the mail server 20 through the IP network 40. Further, in a sequence control between the image processing apparatus 10 and the mail server 20, the communication unit 105 sends various commands to the mail server 20, and receives various commands from the mail server 20. For example, the communication unit 105 sends a “HELLO” command, a “MAIL FROM” command, and a “RSET” command (refer to FIG. 5). Further, the communication unit 105 receives a “220” command, a “250” command, and the likes (refer to FIG. 5).

In the embodiment, the “HELLO” command is sent to the mail server 20 for declaring a start of sending an email. The email address of “mjp@sample.com” assigned to the image processing apparatus 10 is described in the “MAIL FROM” command. When the “RSET” command, i.e., an invalidation request command, is sent to the mail server 20, it is requested that the mail server 20 invalidates all processes that the image processing apparatus 10 performs with respect to the mail server 20 after the image processing apparatus 10 and the mail server 20 establish TCP (Transmission Connection Protocol) connection, i.e., a connection. The “220” command, i.e., a connection establish command, shown in FIG. 5 indicates that the image processing apparatus 10 and the mail server 20 establish the TCP connection, and the “250” command, i.e., a normal reception command, shown in FIG. 5 indicates that the mail server 20 normally receives a command sent from the image processing apparatus 10.

In the embodiment, when the control unit 101 sends a time measurement start request to the timer unit 106 for requesting to start measuring a period of time during which the email thus sent can be canceled, the timer unit 106 starts measuring the period of time. After the period of time, the timer unit 106 sends a time measurement completion signal to the control unit 101.

In the embodiment, when the control unit 101 sends a request to the invalidation request command generation unit 107 for requesting to cancel the email thus sent, the invalidation request command generation unit 107 creates the “RSET” command and sends the “RSET” command to the communication unit 105. Further, after the timer unit 106 clears the period of time thus measured, under control of the control unit 101, the invalidation request command generation unit 107 sends a “QUIT” command, i.e., a connection disconnecting command, to the mail server 20 for requesting disconnection of the TCP connection.

In the embodiment, the setting information storage unit 108 is formed of a flash memory for storing setting information upon reading an original. The setting information includes, for example, setting information of selecting between a flat bed and an ADF (Automatic Document Feeder) for reading an original, setting information of selecting reading between monochrome and color, and setting information of resolution, a file format, and the likes.

In the embodiment, the operational panel 109 is provided for directing to start reading an original, cancel transmission, and the likes. The operational panel 109 includes an operational unit 1091 and a display unit 1092.

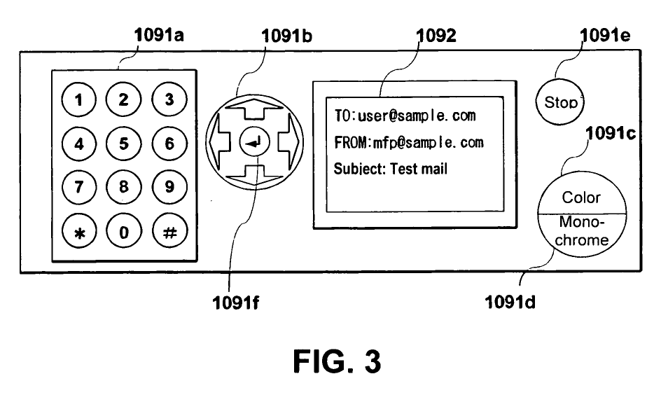

FIG. 3 is a schematic view showing the operational panel 109 of the image processing apparatus 10 according to the first embodiment of the present invention. As shown in FIG. 3, the operational unit 1091 includes a ten-key 1091a, an operational key 1091b, a color start button 1091c, a monochrome start button 1091d, a stop button 1091e, and an execution key 1091f.

In the embodiment, the ten-key 1091a is provided for inputting a text to the display unit 1092. The operational key 1091b is provided for selecting or confirming a list displayed on the display unit 1092. The color start button 1091c is provided for directing to read an original in color. The monochrome start button 1091d is provided for directing to read an original in monochrome.

Further, the stop button 1091e is provided for directing to cancel execution of scanning, transmission of an email, and the likes. The execution key 1091f is provided for directing to create, for example, an email. The display unit 1092 is formed of a liquid crystal display device (LCD) for displaying current status information of the image processing apparatus 10, a display screen necessary for an operation, and the likes.

As shown in FIG. 1, the mail server 20 includes a mailbox 201, a communication unit 202, and a mail deletion unit 203.

In the embodiment, the mailbox 201 stores an email sent from the image processing apparatus 10. The communication unit 202 receives an email from the image processing apparatus 10, and stores the email into the mailbox 201. Further, when the communication unit 202 receives an email transmission request from the personal computer 30, the communication unit 202 retrieves an email thus requested from the mailbox 201, and sends the email to the personal computer 30. Still further, when the communication unit 202 receives the “RSET” command from the image processing apparatus 10, the mail deletion unit 203 sends the “RSET” command to the mail deletion unit 203. When the mail deletion unit 203 receives the “RSET” command from the communication unit 202, the mail deletion unit 203 deletes an email from the mailbox 201.

In the embodiment, the personal computer 30 includes a communication unit 301 for sending and receiving communication information such as an email, and a mailer 302. The mailer 302 retrieves an email sent to the mailbox 201 of the mail server 20 through the IP network 40. More specifically, the personal computer 30 uses the mailer 302 to retrieve an email sent from the image processing apparatus 10 from a mailbox designated with “User@sample.com” in the mail server 20 through the IP network 40.

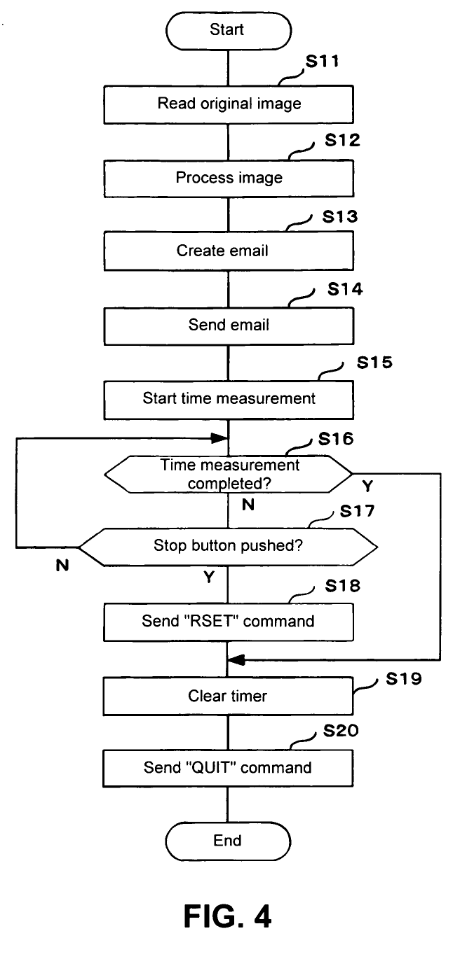

An operation of the image processing apparatus 10 will be explained next. FIG. 4 is a flow chart showing the operation of the image processing apparatus 10 according to the first embodiment of the present invention.

First, a user operates the ten-key 1091a and the operational key 1091b to input the setting information upon reading an original into input columns on a setting information display screen (not shown) displayed on the operational panel 1092. The input columns displayed on the setting information display screen include an input column for inputting a reading method (for example, a flat bed and ADF), an input column for inputting a resolution upon reading an original, an input column for inputting a file format of an image file storing the image data thus read (PDF, TIFF, GIF, JPEG, and the likes), and an input column for inputting selection between reading an original in color or reading an original in monochrome.

When the setting information is input through the operational panel 109, the control unit 101 controls the setting information storage unit 108 to store the setting information.

In the next step, the user operates the ten-key 1091a and the operational key 1091b to display the email transmission display screen on the operational panel 1092 of the operational panel 109. Then, the user operates the ten-key 1091a and the operational key 1091b to input, for example, “user@sample.com” shown in FIG. 3 into the destination input column for specifying a destination of an email. Further, the user operates the ten-key 1091a and the operational key 1091b to input “mfp@sample.com” into the origination input column for specifying an origination of the email. Further, the user operates the ten-key 1091a and the operational key 1091b to input “Test mail” and the likes into the subject column for specifying a title of the email.

In the next step, when the user pushes one of the color start button 1091c and the monochrome start button 1091d, the operational panel 1091 notifies the control unit 101 that one of the color start button 1091c and the monochrome start button 1091d is pushed. When the control unit 101 is notified, the control unit 101 sends the reading start request to the reading unit 102 for requesting to start reading.

In the flow chart shown in FIG. 4, in step S11, when the control unit 101 sends the reading start request to the reading unit 102, the reading unit 102 starts reading an original image, and sends an image signal of the original image to the image processing unit 103 through the control unit 101.

In step S12, when the reading unit 102 sends the image signal of the original image to the image processing unit 103, under control of the control unit 101, the image processing unit 103 creates image data formed of 8 bits, and stores the image data thus created in the RAM. Then, the image processing unit 103 notifies the control unit 101 that the image data of the original image are created. When the image processing unit 103 notifies the control unit 101, the control unit 101 sends the email creation request to the mail creation unit 104.

When the control unit 101 sends the email creation request to the mail creation unit 104, the mail creation unit 104 creates a header of the email. More specifically, the mail creation unit 104 retrieves “TO: user@sample.com” displayed in the destination input column in the email transmission display screen, and writes “TO: user@sample.com” to a destination display column of the header of the email. Further, the mail creation unit 104 retrieves “FROM: mfp@sample.com” displayed in the origination input column in the email transmission display screen, and writes “FROM: mfp@sample.com” to an origination display column of the header of the email. Still further, the mail creation unit 104 retrieves “SUBJECT: Test mail” displayed in the subject column in the email transmission display screen, and writes “SUBJECT: Test mail” to a title display column of the header of the email.

In step S13, after the mail creation unit 104 creates the header of the email, the mail creation unit 104 creates the email with a file formed of the image data retrieved from the RAM attached thereto. Then, the mail creation unit 104 sends the email thus created to the communication unit 105 through the control unit 101.

In step S14, when the communication unit 105 receives the email from the mail creation unit 104, under control of the control unit 101, the communication unit 105 sends the email with the file attached thereto to a mailbox in the mail server 20 specified with “user@sample.com” through the IP network 40. Afterward, the communication unit 105 sends to a “<CR>” command and a “<LF>” command indicating that the email with the file attached thereto is sent (refer to FIG. 5). When the communication unit 105 receives the “250” command indicating that the mail server 20 normally receives the “<CR>” command and the “<LF>” command, the communication unit 105 sends the “250” command to the control unit 101.

When the control unit 101 receives the “250” command from the communication unit 105, the control unit 101 sends the time measurement start request to the timer unit 106 for starting measuring a period of time during which the email thus sent can be canceled.

In step S15, when the timer unit 106 receives the time measurement start request from the control unit 101, the timer unit 106 starts measuring the period of time. In step S16, the control unit 101 determines whether the timer unit 106 sends the time measurement completion signal indicating that the period of time is elapsed and the time measurement is completed. When the control unit 101 determines that the timer unit 106 sends the time measurement completion signal, the process proceeds to step S19.

In step S17, when the control unit 101 determines that the timer unit 106 does not send the time measurement completion signal, the control unit 101 determines whether the operational panel 109 sends a notice indicating that the user pushes the stop button 1091e of the operational panel 1091. When the control unit 101 determines that the operational panel 109 does not send the notice indicating that the user pushes the stop button 1091e, the process returns to step S16. When the control unit 101 determines that the operational panel 109 sends the notice indicating that the user pushes the stop button 1091e, the control unit 101 sends a request to the invalidation request command generation unit 107 for cancelling the email thus sent.

When the control unit 101 sends the request to the invalidation request command generation unit 107, the invalidation request command generation unit 107 sends the “RSET” command to the communication unit 105. The “RSET” command requests that the mail server 20 invalidates all processes that the image processing apparatus 10 performs with respect to the mail server 20 after the image processing apparatus 10 and the mail server 20 establish TCP (Transmission Connection Protocol) connection. The processes include a process of deleting the email stored in the mailbox designated with “user@sample.com”.

In step S18, when the communication unit 105 receives the “RSET” command from the invalidation request command generation unit 107, under control of the control unit 101, the communication unit 105 sends the “RSET” command to the mail server 20 through the IP network 40. In step S19, under control of the control unit 101, the timer unit 106 stops measuring the period of time, and clears the period of time thus measured.

In step S20, when the timer unit 106 clears the period of time thus measured, under control of the control unit 101, the invalidation request command generation unit 107 sends the “QUIT” command to the mail server 20, thereby completing the process.

FIG. 5 is a sequence chart showing the sequence between the image processing apparatus 10 and the mail server 20 according to the first embodiment of the present invention.

In step S21, the image processing apparatus 10 sends a “SYN” command to the mail server 20 through the IP network 40. In step S22, when the mail server 20 receives the “SYN” command from the image processing apparatus 10, the mail server 20 sends a “SYN, ACK” command indicating that the mail server 20 normally receives the “SYN” command to the image processing apparatus 10 through the IP network 40.

In step S23, when the image processing apparatus 10 receives the “SYN, ACK” command from the mail server 20, the image processing apparatus 10 sends an “ACK” command indicating that the image processing apparatus 10 normally receives the “SYN, ACK” command to the mail server 20 through the IP network 40. In step S24, when the mail server 20 receives the “ACK” command from the image processing apparatus 10, the mail server 20 sends the “220” command described as “192.168.100.100 Service Ready” to the image processing apparatus 10. The “220” command indicates that a connection is established between the mail server 20 and the image processing apparatus 10 with an IP address “192.168.100.100” assigned thereto. At this moment, the TCP (Transmission Connection Protocol) connection is established between the image processing apparatus 10 and the mail server 20.

In step S25, when the TCP connection is established between the image processing apparatus 10 and the mail server 20, the image processing apparatus 10 sends the “HELLO” command described as “192.168.100.100” to the mail server 20. The “HELLO” command is sent for declaring a start of sending an email to the mail server 20 with the IP address “192.168.100.200” assigned thereto.

In step S26, when the mail server 20 receives the “HELLO” command from the image processing apparatus 10, the mail server 20 sends the “250” command described as “192.168.100.100”, i.e., the IP address assigned to the image processing apparatus 10, to the image processing apparatus 10 through the IP network 40. The “250” command indicates that the mail server 20 acknowledges the declaration described in the “HELLO” command.

In step S27, when the image processing apparatus 10 receives the “250” command from the mail server 20, the image processing apparatus 10 sends the “MAIL FROM” command described as “mfp@sample.com” indicating an email address assigned to the mail server 20.

In step S28, when the mail server 20 receives the “MAIL FROM” command from the image processing apparatus 10, the mail server 20 sends the “250” command described as “OK” indicating that the mail server 20 normally receives the “MAIL FROM” command to the image processing apparatus 10 through the IP network 40.

In step S29, when the image processing apparatus 10 receives the “250” command from the mail server 20, the image processing apparatus 10 sends an “RCPT” command described as “user@sample.com” indicating the email address assigned to the personal computer 30 to the mail server 20.

In step S30, when the mail server 20 receives the “RCPT” command from the image processing apparatus 10, the mail server 20 sends the “250” command described as “OK” indicating that the mail server 20 normally receives the “RCPT” command to the image processing apparatus 10 through the IP network 40.

In step S31, when the image processing apparatus 10 receives the “250” command from the mail server 20, the image processing apparatus 10 sends a “DATA” command indicating that the image processing apparatus 10 sends data (a mail header, a text, and attached image data) to the mail server 20 through the IP network 40.

In step S32, when the mail server 20 receives the “DATA” command from the image processing apparatus 10, the mail server 20 sends a “354” command described as “Start mail input; end with <CRLF><CRLF>” to the image processing apparatus 10 through the IP network 40. The “354” command defines the text to be placed at a position away from a last line of the header by two lines.

In step S33, when the image processing apparatus 10 receives the “354” command from the mail server 20, the image processing apparatus 10 sends the text and the attachment file placed at the position away from the last line of the header by two lines to the mail server 20 through the IP network 40. Accordingly, the mail server 20 stores the email sent from the image processing apparatus 10 to a mailbox identified with “user@sample.com” assigned to the personal computer 30.

In step S34, when the image processing apparatus 10 completes sending the image data attached to the email to the mail server 20, the image processing apparatus 10 sends a command described as “<CR><LF>” to the image processing apparatus 10 through the IP network 40.

In step S35, when the mail server 20 receives the command described as “<CR><LF>” from the image processing apparatus 10, the mail server 20 sends the “250” command described as “OK” indicating that the mail server 20 normally receives the command described as “<CR><LF>” to the image processing apparatus 10 through the IP network 40. After step S35, the communication does not end for a specific period of time, and it becomes a waiting state.

In step S36, when the user wants to cancel the email sent to the mail server 20, that is, to delete the email stored in the mailbox identified with “user@sample.com”, the image processing apparatus 10 sends the “RSET” command to the mail server 20 through the IP network 40.

In step S37, when the mail server 20 receives the “RSET” command from the image processing apparatus 10, the mail server 20 sends the “250” command described as “OK” indicating that the mail server 20 normally receives the “RSET” command to the image processing apparatus 10 through the IP network 40. Afterward, the mail server 20 deletes the email stored in the mailbox identified with “user@sample.com”, thereby canceling the email thus sent by the user.

In step S38, when the image processing apparatus 10 receives the “250” command from the mail server 20, the image processing apparatus 10 sends the “QUIT” command to the mail server 20 through the IP network 40.

In step S39, when the mail server 20 receives the “QUIT” command from the image processing apparatus 10, the mail server 20 sends a “221” command described as “192.168.100.100”, i.e., the IP address assigned to the image processing apparatus 10, and “Service Closing transmission channel” to the image processing apparatus 10 through the IP network 40. The “221” command indicates that the mail server 20 normally completes the processes required from the image processing apparatus 10. In other words, the mail server 20 deletes the email stored in the mailbox identified with “user@sample.com”. When the steps described above are completed, the sequence between the image processing apparatus 10 and the mail server 20 is completed.

In the embodiment, the personal computer 30 uses the mailer 302 to read the email sent from the image processing apparatus 10 from the mailbox identified with “user@sample.com” through the IP network 40.

As described above, in the embodiment, after the image processing apparatus 10 receives the “250” command from the mail server 20 indicating that the mail server 20 normally receives the email, the image processing apparatus 10 sends the “RSET” command to the mail server 20 for invalidating the email sent from the image processing apparatus 10. When the mail server 20 receives the “RSET” command from the image processing apparatus 10, the mail deletion unit 203 deletes the email stored in the mailbox 201.

Accordingly, it is not necessary for the sender of the email to contact an administrator of the mail server 20 through an email or telephone to request deletion of the email sent previously, thereby eliminating time and work thereof. Further, the administrator of the mail server does not need to delete the email, thereby eliminating time and work thereof.

Further, in the embodiment, when the image processing apparatus 10 receives the “250” command indicating that the mail server 20 normally receives the email, the timer unit 106 measures five minutes, i.e., the period of time during which the “RSET” command can be sent to the mail server 20 to cancel the email sent to the mail server 20 previously. Accordingly, it is possible to provide the sender of the email with a sufficient period of time for canceling the email.

In a modified example of the first embodiment, the mail server 20 may be configured such that, when the email sent from the image processing apparatus 10 is stored in the mailbox 201, the email is accessible only from the image processing apparatus 10 or the sender for a specific period of time.

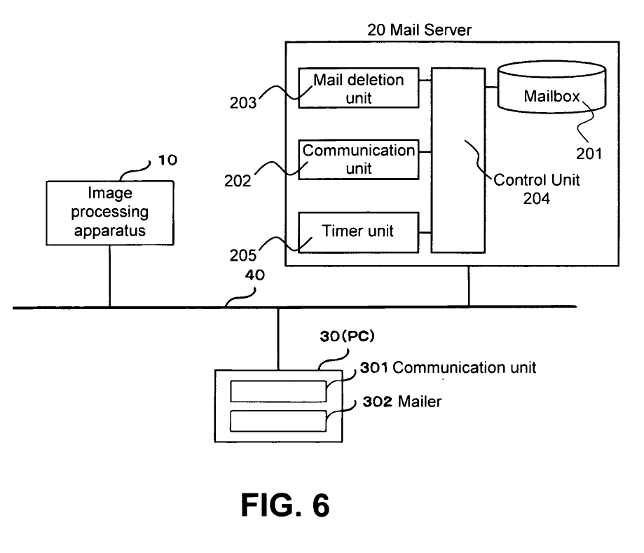

FIG. 6 is a block diagram showing an image processing system according to the modified example of the first embodiment of the present invention. In the image processing system, the image processing apparatus 10 has a configuration the same as that in the first embodiment. As shown in FIG. 6, the mail server 20 includes a control unit 204 and a timer unit 205, in addition to the configuration thereof in the first embodiment.

In the modified example, the control unit 204 has a function of controlling an access to the email thus received. After the email is received and stored in the mailbox 201, when the mail server 20 sends the “250” command to the image processing apparatus 10, the control unit 204 prohibits an access to the email except the sender of the email. After a specific period of time, the control unit 204 allows an access to the email. The timer unit 205 measures a period of time from when the email is received and the “250” command is sent.

In the modified example, the email is accessible only from the sender for a specific period of time. Accordingly, it is possible to prevent a receiver of the email from seeing the email before the sender request to delete the email. It may be configured such that the administrator of the mail server 20 or the sender of the email determines arbitrarily the specific period of time, or the specific period of time may be set equal to a period of time during which the “RSET” command can be sent to the mail server 20 for invalidating the email sent to the mail server 20.

### Second Embodiment

A second embodiment of the present invention will be explained next. Components in the second embodiment similar to those in the first embodiment are designated with the same reference numerals, and explanations thereof are omitted. Explanations of operations and effects in the second embodiment similar to those in the first embodiment are omitted.

Similar to the first embodiment, the image processing system in the second embodiment includes an image processing apparatus 50, the mail server 20; the personal computer (PC) 30; and the IP network 40 connected to the image processing apparatus 50, the mail server 20, and the personal computer 30.

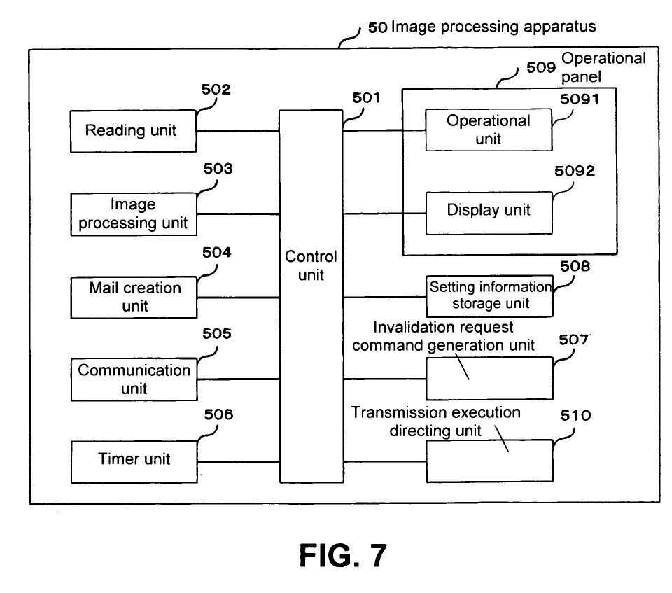

FIG. 7 is a block diagram showing the image processing apparatus 50 of the image processing system according to the second embodiment of the present invention.

As shown in FIG. 7, the image processing apparatus 50 includes a control unit 501; a reading unit 502; an image processing unit 503; a mail creation unit 504; a communication unit 505; a timer unit 506; an invalidation request command generation unit 507; a setting information storage unit 508; an operational panel 509; and a transmission execution directing unit 510.

In the embodiment, a CPU (not shown) executes a program stored in an ROM (not shown) to constitute the control unit 501, the reading unit 502, the image processing unit 503, the mail creation unit 504, the communication unit 505, the timer unit 506, the invalidation request command generation unit 507, and the transmission execution directing unit 510 each having a function described later. Each of the reading unit 502, the image processing unit 503, the mail creation unit 504, the communication unit 505, the timer unit 506, the invalidation request command generation unit 507, and the setting information storage unit 508 has a configuration similar to that in the first embodiment.

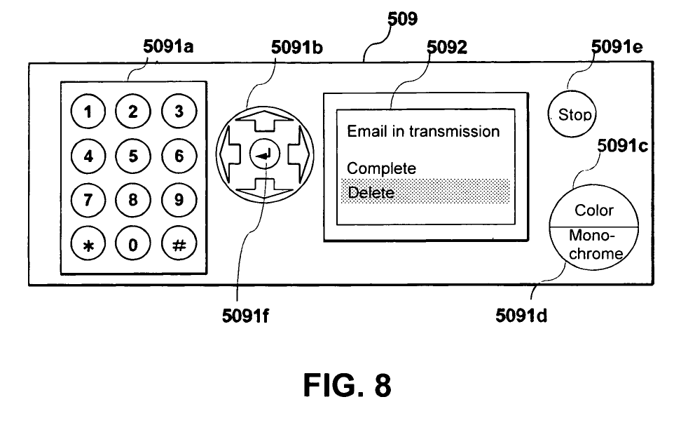

In the embodiment, in addition to the function of the control unit 101 in the first embodiment, the control unit 501 determines whether the control unit 501 receives a transmission completion notice from the transmission execution directing unit 510 when it is determined that the operational panel 509 does not send a notice that a stop button 5091e (refer to FIG. 8) is pushed.

When the control unit 501 determines that the control unit 501 receives the transmission completion notice from the transmission execution directing unit 510, the control unit 501 sends a direction to the timer unit 506 for clearing a measured period of time. When the control unit 501 determines that the control unit 501 does not receive the transmission completion notice from the transmission execution directing unit 510, the control unit 501 controls the timer unit 506 to continue measuring a time.

In the embodiment, in addition to the function of the timer unit 106 in the first embodiment, the timer unit 506 clears the measured period of time according to the direction sent from the timer unit 506 for clearing the measured period of time.

In the embodiment, in addition to the function of the invalidation request command generation unit 107 in the first embodiment, the invalidation request command generation unit 507 sends a request to the control unit 501 for requesting to delete an email previously sent when the invalidation request command generation unit 507 receives a notice through the control unit 501 indicating that a deletion display column displayed as “Delete” in a transmission completion/deletion direction display screen (refer to FIG. 8) is specified.

FIG. 8 is a schematic view showing the operational panel 509 of the image processing apparatus 50 according to the second embodiment of the present invention. As shown in FIG. 8, the operational panel 509 includes an operational unit 5091 and a display unit 5092.

As shown in FIG. 8, the operational unit 5091 includes a ten-key 5091a, an operational key 5091b, a color start button 5091c, a monochrome start button 5091d, a stop button 5091e, and an execution key 5091f. Each of the ten-key 5091a, the operational key 5091b, the color start button 5091c, the monochrome start button 5091d, the stop button 5091e, and the execution key 5091f has a function the same as that in the first embodiment.

In the embodiment, in addition to the display screen displayed on the display unit 1092 in the image processing apparatus 50 in the first embodiment, the display unit 5092 displays the transmission completion/deletion direction display screen.

As shown in FIG. 8, the transmission completion/deletion direction display screen includes a completion display column displaying “Complete” for specifying that the email in transmission is completed, and the deletion display column displaying “Delete” for specifying that the email in transmission is deleted from the mailbox 201 of the mail server 20.

In the embodiment, when the transmission execution directing unit 510 receives a notice through the control unit 501 indicating that the completion display column in the transmission completion/deletion direction display screen is specified, the transmission execution directing unit 510 sends a transmission completion request to the control unit 501 for requesting to complete transmission of an email previously sent.

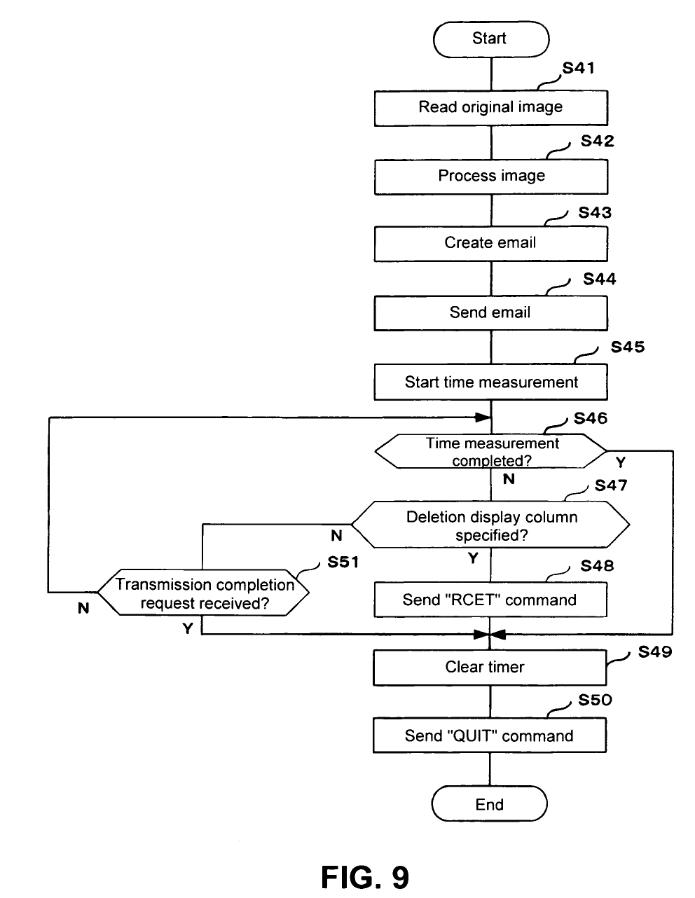

An operation of the image processing apparatus 50 will be explained next. FIG. 9 is a flow chart showing the operation of the image processing apparatus 50 according to the second embodiment of the present invention. A process from step S41 of reading an original image to step S46 of determining whether the time measurement shown in FIG. 9 is completed is the same as the process from step S11 to step S16 shown in FIG. 4 performed with the image processing apparatus 10 in the first embodiment.

In step S47, the control unit 501 determines whether the control unit 501 receives the notice from the operational panel 509 indicating that the deletion display column displayed as “Delete” in the transmission completion/deletion direction display screen displayed on the display unit 5092 (refer to FIG. 8) is specified.

When the control unit 501 determines that the control unit 501 receives the notice from the operational panel 509 indicating that the deletion display column is specified, the image processing apparatus 50 performs a process from step S48 of sending the “RCET” command to the mail server 20 to step S50 of sending the “QUIT” command to the mail server 20, thereby completing the process, similar to the process from step S18 to complete the process through step S20 shown in FIG. 4 performed with the image processing apparatus 10 in the first embodiment.

In step S51, when the control unit 501 determines that the control unit 501 does not receive the notice from the operational panel 509 indicating that the deletion display column is specified, the control unit 501 determines whether the control unit 501 receives the transmission completion request from the transmission execution directing unit 510 for requesting to complete transmission of the email previously sent.

When the control unit 501 determines that the control unit 501 receives the transmission completion request from the transmission execution directing unit 510, the control unit 501 sends a direction to the timer unit 506 to clear the measured period of time, and proceeds to step S49. When the control unit 501 determines that the control unit 501 does not receive the transmission completion request from the transmission execution directing unit 510, the process proceeds to step S46.

As described above, in the second embodiment, when the control unit 501 of the image processing apparatus 50 receives the transmission completion request from the transmission execution directing unit 510 for requesting to complete transmission of the email, the timer unit 506 clears the measured period of time. Accordingly, as compared with the image processing apparatus 10 in the first embodiment, it is possible to send the “QUIT” command as the connection disconnecting command for disconnecting the connection to the mail server 20 for cancelling the established connection between the image processing apparatus 50 and the mail server 20 more quickly.

In the first embodiment and the second embodiment, the image processing apparatus 10 and the image processing apparatus 50 include the reading unit 102 and the reading unit 502, respectively, and do not need to include the reading unit 102 and the reading unit 502. For example, a communication apparatus such as an ordinary personal computer (PC) or a terminal device (PDA or mobile phone) may send an email to the mail server.

In the first embodiment and the second embodiment, the image processing apparatus 10 and the image processing apparatus 50 are connected to a priority network as the IP network, respectively. Alternatively, the image processing apparatus 10 and the image processing apparatus 50 may be connected to a wireless network using wireless communication.

In the first embodiment and the second embodiment, the image processing apparatus 10 and the image processing apparatus 50 send the email with the attached file to the mail server 20, respectively. Alternatively, the image processing apparatus 10 and the image processing apparatus 50 may send the email without the attached file to the mail server 20, respectively.

The disclosure of Japanese Patent Application No. 2007-283491, filed on Oct. 31, 2007, is incorporated in the application by reference.

While the invention has been explained with reference to the specific embodiments of the invention, the explanation is illustrative and the invention is limited only by the appended claims.

What is claimed is:

1. An image processing system, comprising:
an image processing apparatus;
a network connected to the image processing apparatus; and
a mail server connected to the image processing apparatus through the network,
wherein said image processing apparatus comprises,
a first communication unit for receiving a normal reception command from the mail server indicating that the mail server normally receives an email; and
an invalidation request command generation unit for generating an invalidation request command for requesting invalidation of the email when the invalidation request command generation unit receives a direction for requesting invalidation of the email after the first communication unit receives the normal reception command, and
said mail server comprises,
a second communication unit for sending the normal reception command to the image processing apparatus after the mail server normally receives the email; and
a mail deletion unit for deleting the email specified by the invalidation request command when the mail deletion unit receives the invalidation request command.

2. The image processing system according to claim 1, wherein said image processing apparatus further includes a timer unit for measuring a first period of time during which the invalidation request command is allowed to be sent to the mail server when the first communication unit receives the normal reception command.

3. The image processing system according to claim 1, wherein said mail server further includes a timer unit for measuring a second period of time during which the email is not accessible except through the image processing apparatus when the first communication unit receives the normal reception command.

4. The image processing system according to claim 2, wherein said image processing apparatus further includes a control unit for sending a connection disconnecting command to the mail server for cancelling a connection established between the image processing apparatus and the mail server when the timer unit measures the first period.

5. The image processing system according to claim 4, said control unit is adopted to send the connection disconnecting command during the first period after the invalidation request command is sent.

6. The image processing system according to claim 4, wherein said image processing apparatus further includes a transmission execution directing unit for directing the control unit to send the connection disconnecting command when the transmission execution directing unit receives a request to complete transmission of the email.

7. The image processing system according to claim 6, wherein said timer unit is adopted to clear the first period when the control unit sends the connection disconnecting command.

8. An image processing apparatus connected to a mail server through a network, comprising
a communication unit for receiving a normal reception command from the mail server indicating that the mail server normally receives an email; and
an invalidation request command generation unit for generating an invalidation request command for requesting invalidation of the email when the invalidation request command generation unit receives a direction for requesting invalidation of the email after the communication unit receives the normal reception command.

9. The image processing apparatus according to claim 8, further comprising a timer unit for measuring a first period of time during which the invalidation request command is allowed to be sent to the mail server when the communication unit receives the normal reception command.

10. The image processing apparatus according to claim 9, further comprising a control unit for sending a connection disconnecting command to the mail server for cancelling a connection established between the image processing apparatus and the mail server when the timer unit measures the first period.

11. The image processing apparatus according to claim 10, said control unit is adopted to send the connection disconnecting command during the first period after the invalidation request command is sent.

12. The image processing apparatus according to claim 10, further comprising a transmission execution directing unit for directing the control unit to send the connection disconnecting command when the transmission execution directing unit receives a request to complete transmission of the email.

13. The image processing apparatus according to claim 12, wherein said timer unit is adopted to clear the first period when the control unit sends the connection disconnecting command.

14. A mail server connected to a communication apparatus through a network, comprising:
a mail deletion unit for deleting an email specified by an invalidation request command upon receiving the invalidation request command sent from the communication apparatus.

15. The mail server according to claim 14, further comprising a communication unit for sending a normal reception command to the communication apparatus after receiving the email sent from the communication apparatus normally.

16. The mail server according to claim 15, further comprising a timer unit for measuring a period of time during which the email is not accessible except through the communication apparatus when the communication unit sends the normal reception command.

17. A method of sending an email from a communication apparatus to a mail server through a network, comprising the steps of:
generating an invalidation request command with the communication apparatus for requesting invalidation of the email when a direction for requesting invalidation of the email sent to the mail server is received;
sending the invalidation request command to mail server; and
deleting the email specified by the invalidation request command with the mail server when the invalidation request command is received.

18. The method of sending an email according to claim 17, further comprising the step of receiving a normal reception command with the communication apparatus from the mail server indicating that the email is received normally, wherein said communication apparatus generates and sends the invalidation request command to the mail server after the communication apparatus receives the normal reception command.

19. The method of sending an email according to claim 18, further comprising the step of controlling a timer unit with the communication apparatus to measure a first period of time during which the invalidation request command is allowed to be sent to the mail server when the normal reception command is received.

20. The method of sending an email according to claim 18, further comprising the step of controlling a timer unit with the mail server to measure a second period of time during which the email is not accessible except through the communication apparatus when the normal reception command is received.
